(19) United States
(12) Patent Application Publication
(10) Pub. No.: US 2003/0210408 A1
(43) Pub. Date: Nov. 13, 2003

(54) Method of measuring thickness of layer

(76) Inventors: Chungsam Jun, Suwon-City (KR); Sangmun Chan, Yongin-City (KR); Pilsik Hyun, Suwon-City (KR); Hyungsuk Cho, Suwon-City (KR); Sangbong Choi, Suwon-City (KR)

Correspondence Address: VOLENTINE FRANCOS, P.L.L.C., Suite 150, 12200 Sunrise Valley Drive, Reston, VA, 20191, US

(21) Appl. No.: 10/436,147

(22) Filed: May 13, 2003

(30) Foreign Application Priority Data
May 13, 2002 (KR) 02-26227

(51) Int. Cl. G01B 11/28

(52) U.S. Cl. 356/630

(57) ABSTRACT

The thickness of a thin layer is measured in which a patterned lower layer is formed on a substrate, and an upper layer covering the lower layer is formed. The lower layer is modeled, and then the thickness of the upper layer is measured. When modeling the lower layer, the lower layer is set as a predetermined material layer, and then the material layer is fit into the lower layer using a harmonic oscillator model using an asorptivity, a refractive index, and a thickness of the material layer as parameters. Accordingly, the thickness of a thin layer formed in a cell area can be directly measured in real-time. Also, the thickness uniformity of the thin layer can be measured in each shot area or each chip area. Furthermore, the thickness of a portion of the thin layer formed in a chip at the edge of wafer can be measured. As a result, the method can be applied to improve processes and analyze problems of the processes.

### BACKGROUND OF THE INVENTION

1. Field of the Invention

The present invention generally relates to a method of measuring the thickness of a thin layer, and more particularly, the present invention relates to a method of measuring the thickness of a thin layer in the cell area of a semiconductor device, as well as the thickness of the thin layer on the outermost edge of the semiconductor device.

A claim of priority is made to Korean Patent Application No. 2002-26227, filed May 13, 2002, the entirety of which is incorporated herein by reference.

2. Description of the Related Art

Together with increases in integration density of semiconductor devices, the number of thin layers stacked over the substrates of such devices has sharply increased. The formation of a thin layer over a substrate is therefore often followed by processes for forming additional thin layers stacked over the substrate, and accordingly, the physical characteristics of an already deposited layer can impact processing parameters of subsequently formed layers. Thus, upon the formation of a thin layer, it is preferable that characteristics of the thin layer are measured, and the measured results are utilized when determining parameters of a subsequent layer formation process. For example, an already formed thin layer may be measured to determine whether the layer is of uniform thickness, and the determined result may be applied to a subsequent layer process to ensure that the next layer is formed to a more uniform thickness.

Therefore, the thickness of each layer of a multi-layered thin layer stacked on a substrate is an important processing parameter. A thin layer that is not formed to a desired thickness in one process may be an obstacle to proper formation of a next layer in a next process. For example, a photosensitive layer may not be uniformly coated in a subsequent process if the underlying thin layer of a prior process is not properly formed within specified thicknesses. The margin of the photolithographic process may therefore decrease, which results in a reduction in semiconductor device yield.

For this reason, particularly as a result of the sharp increase in integration density, it is important to measure the thickness of thin layers as they are formed in the manufacture of semiconductor devices.

Various methods of measuring the thickness of a thin layer have been suggested, and among these, some of these methods are widely used.

Conventionally used methods measure the thickness of a thin layer outside a cell area of the semiconductor device. This is because the cell area contains an underlying pattern which causes optical inference when the cell area is irradiated. As such, a non-cell site of the semiconductor device is used to measure the thickness of a thin layer.

For example, as shown in FIGS. 1 and 2, the measurement of the thickness of a thin layer 2 formed on a wafer 1, particularly the thickness of an upper layer formed in cell areas B in which lower patterns 3 are formed, is estimated by measuring a portion of the thin layer 2 in a non-cell site A between the cell areas B. The non-cell site A, in which patterns are not formed, is flat. The size of the non-cell site A is set to be within the range of 20×20-100×200 μm² in consideration of the size of a spot of a beam radiated onto the non-cell site A to measure the thickness of the thin layer 2.

The thickness of a portion of a thin layer formed in the non-cell site A is measured to indirectly measure the thickness of a portion of the thin layer formed in the cell areas B. Thus, it is difficult to accurately measure the thickness of the portion of the thin layer formed in the cell areas B. In particular, it is difficult to measure the uniformity of the thickness of a thin layer in a shot or a chip. Also, since the non-cell site A, which is additionally prepared to measure the thickness of a thin layer, is positioned 10-20 mm inside from the outermost edge of the wafer 1, it is difficult to measure the characteristic of the thickness of a portion of the thin layer formed on the outermost edge of the wafer 1.

The above-discussed drawbacks may be improved by using a vertical scanning electron microscope (VSEM). However, to use the VSEM, a wafer must be cut into test pieces, and then the test pieces must be analyzed. Thus, a large amount of time is required, thus substantially reducing productivity of the fabrication process.

### SUMMARY OF THE INVENTION

According to an aspect of the present invention, there is provided a method of measuring the thickness of a thin layer in which a lower layer patterned to a shape is formed on a substrate, an upper layer covering the lower layer is formed, and the thickness of the upper layer is measured. The lower layer is modeled, and the thickness of the upper layer is measured using the modeling results of the lower layer.

When modeling the lower layer, the lower layer is set as a predetermined material layer. The material layer is fit into the lower layer using a harmonic oscillator model which employs asorptivity, refractive index, and thickness of the material layer as parameters.

The upper layer may be a material layer that has been subject to chemical mechanical polishing.

The thickness of a portion of the upper layer formed in a predetermined area of the substrate is measured. Here, the predetermined area includes at least a cell area.

The thickness of the upper layer may be measured using a spectroscope ellipsometer.

According to the present invention, the thickness of a thin layer formed in a cell area can be directly measured in real-time. Also, the thickness uniformity of the thin layer can be measured in each shot area or each chip area. Furthermore, the thickness of a portion of the thin layer formed in a chip at the edge of a wafer can be measured. As a result, the method can be applied to improve processes and analyze problems of the processes.

### BRIEF DESCRIPTION OF THE DRAWINGS

The above and other features and advantages of the present invention will become more readily apparent from the detailed description that follows, with reference to the accompanying drawings, in which:

FIG. 1 is a plane view of a wafer;

FIG. 2 is a cross-sectional view of an enlarged portion of the wafer shown in FIG. 1;

FIG. 3 is a cross-sectional view of a portion of a cell area of a substrate in which a lower layer and an upper layer are sequentially formed;

FIG. 4 is a graph illustrating a spectroscopic ellipsometer (SE) spectrum occurring when measuring the thickness of a thin layer in an additional non-cell site using an SE as a tangential value of an amplitude reflective rate to a wavelength of an incident beam according to an embodiment of the present invention;

FIG. 5 is a graph illustrating an SE spectrum occurring when measuring the thickness of a thin layer in an additional non-cell site using an SE as a cosine value of a phase difference to a wavelength of an incident beam according to an embodiment of the present invention;

FIG. 6 is a graph illustrating an SE spectrum occurring when measuring the thickness of a thin layer formed in a cell area using an SE as a tangential value of an amplitude reflective rate to a wavelength of an incident beam according to an embodiment of the present invention;

FIG. 7 is a graph illustrating an SE spectrum occurring when measuring the thickness of a thin layer formed in a cell area using an SE as a cosine value of a phase difference to a wavelength of an incident beam according to an embodiment of the present invention;

FIG. 8 is a graph illustrating the correlation between the thickness of an oxide layer formed in a non-cell site and the thickness of an oxide layer formed in a cell area, where the thicknesses of the oxide layers are measured in a first experiment according to the present invention;

FIG. 9 is a graph illustrating variations in the thickness of an oxide layer formed in a cell area and the thickness of an oxide layer formed in a non-cell site adjacent to the cell area, where the thicknesses of the oxide layers are measured in a second experiment according to the present invention;

FIG. 10 is a graph illustrating the correlation between the thicknesses of the oxide layers formed in the cell area and the non-cell site measured in the second experiment according to the present invention;

FIG. 11 is a graph illustrating the thickness of an oxide layer formed in a non-cell site and the thickness of an oxide layer formed in a cell area at each point, where the thicknesses of the oxide layers are measured in a third experiment according to the present invention;

FIG. 12 is a graph illustrating the correlation between the thicknesses of the oxide layers formed in the non-cell site and the cell area measured in the third experiment according to the present invention;

FIG. 13 is a graph illustrating variations in the thickness of an upper layer formed in a cell area and in a non-cell site at each point, where the thickness of the upper layer is measured in a fourth experiment according to the present invention;

FIG. 14 is a graph illustrating the correlation between the thickness of a portion of the upper layer in the cell area and the thickness of a portion of the upper layer in the non-cell site measured in the fourth experiment according to the present invention;

FIG. 15 is a graph illustrating the thickness of an upper layer measured using an SE spectrum and a VSEM to verify a method of measuring the thickness of a thin layer according to an embodiment of the present invention, at each point;

FIG. 16 is a graph illustrating the correlation between the thickness of an upper layer measured by fitting an SE spectrum and the thickness of an upper layer measured via a VSEM in a process of verifying a method of measuring the thickness of a thin layer according to an embodiment of the present invention;

FIG. 17 is a graph illustrating the results of the thickness of an upper layer formed in a shot area of a substrate measured using a method of measuring the thickness of a thin layer according to an embodiment of the present invention;

FIG. 18 is a graph illustrating the results of the thickness of a thin layer formed in a chip area measured using a method of measuring the thickness of a thin layer according to an embodiment of the present invention;

FIG. 19 is a graph illustrating the results of the thickness of a thin layer formed on the outermost cell area not including a non-cell site for measuring the thickness of a thin layer, where the thickness of the thin layer in the cell area is measured using a method of measuring the thickness of a thin layer according to an embodiment of the present invention; and

FIG. 20 is a block diagram of steps of a method of measuring the thickness of a thin layer according to an embodiment of the present invention.

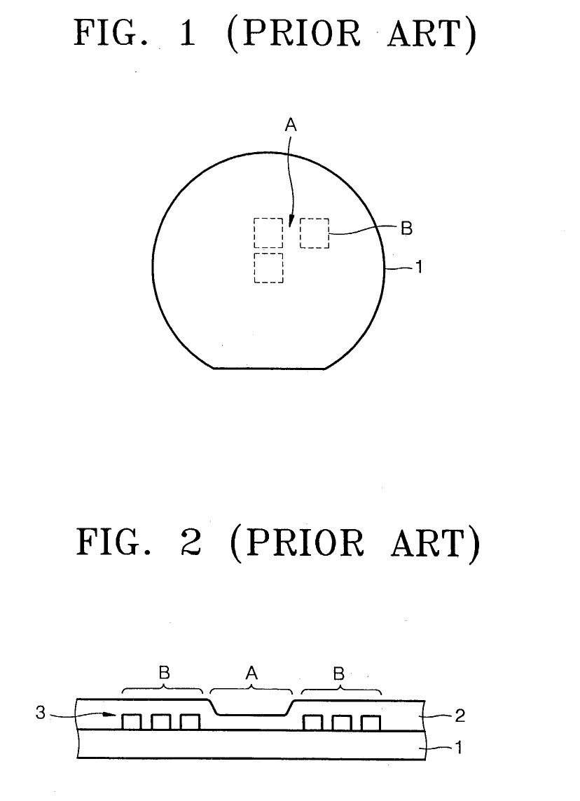

### DETAILED DESCRIPTION OF THE PREFERRED EMBODIMENTS

Hereinafter, a method of measuring the thickness of a thin layer according to non-limiting embodiments of the present invention will be described in detail with reference to the accompanying drawings.

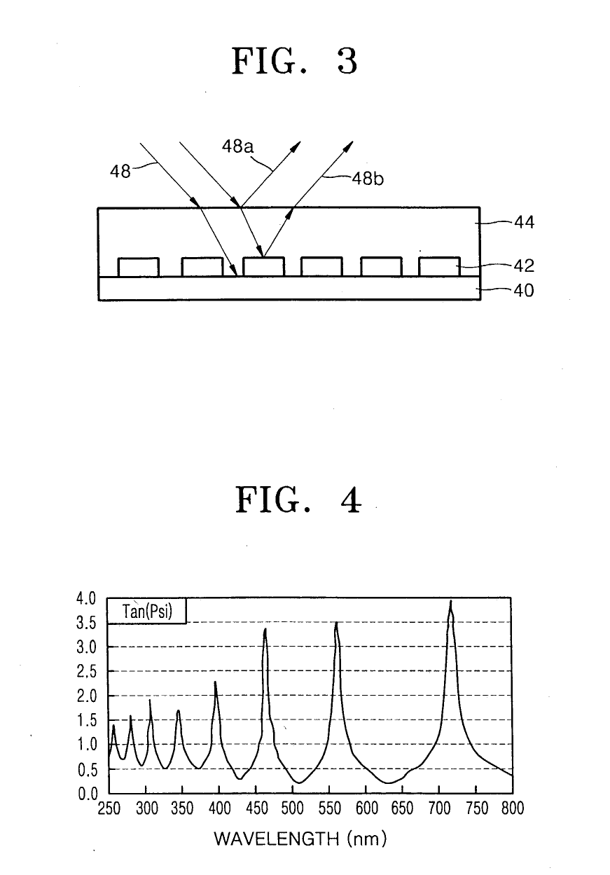

FIG. 3 is a cross-sectional view of a portion of a cell area of a substrate. Reference numeral 40 denotes a semiconductor substrate, e.g., a p-type silicon substrate, and reference numeral 42 denotes a pattern (hereinafter, referred to as lower layer 42) formed on the semiconductor substrate 40. Reference numeral 44 denotes an upper layer covering the lower layer 42.

The thickness of the upper layer 40, in which material layers are stacked on the substrate 40, may be measured by radiating a beam 48 onto the upper layer 44, detecting beams 48a and 48b reflected on the upper layer 44 and lower layer 42, respectively, and comparing the phases or polarizations between the detected beams 48a and 48b. Here, the reflected beams 48a and 48b are the beam 48a reflected on the surface of the upper layer 44 and the beam 48b reflected on the lower layer 42.

However, the lower layer 42 is not uniformly formed on the entire surface of the semiconductor substrate 40. As shown in FIG. 3, in a case where the lower layer 42 is formed of a plurality of pattern portions spaced apart from each other, the state of the reflected beam 48b varies due to the plurality of pattern portions. In other words, in the event that the incident beam 48 is a beam reflected from a lower layer formed to a uniform thickness on the entire surface of the semiconductor substrate 40, the beam 48 includes accurate information on the thickness of the upper layer 44. In contrast, in a case where the incident beam 48 is a beam reflected from a lower layer composed of a plurality of pattern portions spaced apart from each other on the substrate 40, the incident beam 48 includes information on the plurality of pattern portions as well as the information on the thickness of the upper layer 44. Thus, it may be difficult to obtain accurate information on the thickness of the upper layer 44 using the latter reflected beam.

For this reason, the thickness of a portion of the upper layer 44 formed in an additional non-cell site (not shown) in which the plurality of patterns are not formed is measured to indirectly measure the thickness of a portion of the upper layer 44 formed in the cell area.

Considering the correlation between the incident beam 48 and the reflected beams 48a and 48b, in a case where the upper layer 44 is much thicker than the lower layer 42, most of the information included in the reflected beams 48a and 48b may be regarding the upper layer 44. In other words, the state of the incident beam 48, e.g., the intensity or polarization of the incident beam 48, is affected by the physical characteristics of the upper layer 44, e.g., the thickness, the refractive index, the absorptivity, the crystallinity, and the like. The variation in the states of the incident beam 48 and the reflected beams 48a and 48b depends on the physical characteristics of the upper layer 44. Thus, the physical characteristics of the upper layer 44 may be measured through analysis of the reflected beams 48a and 48b.

Accordingly, even though the lower layer 42 is formed of a plurality of pattern portions, in a case where the upper layer 44 is thick, the thickness of the upper layer 44 can be accurately measured by optimising parameters of the lower layer 42 through modelling of the lower layer 42 in a specific wavelength bandwidth. This means that the thickness of the upper layer 44 can be measured in a cell area as well as in a non-cell site.

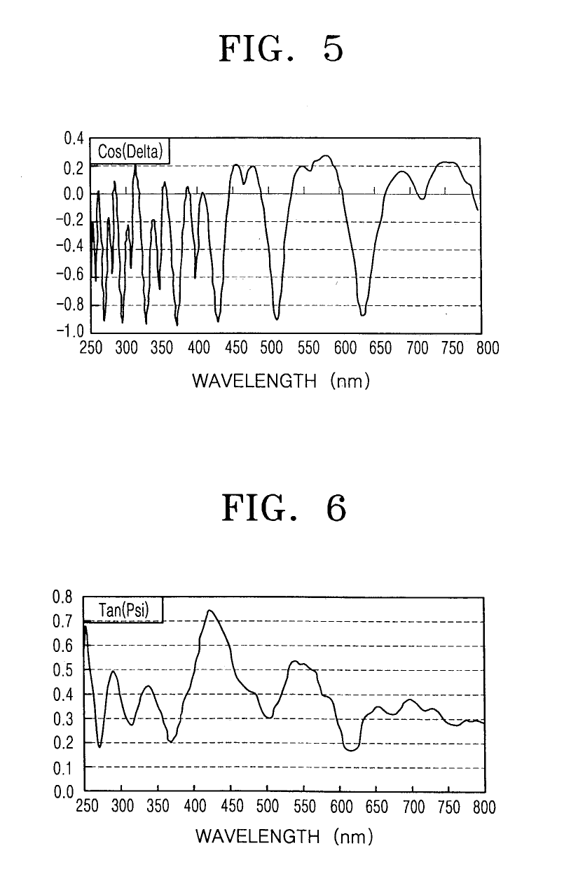

This will be described in detail with reference to FIGS. 4 through 7.

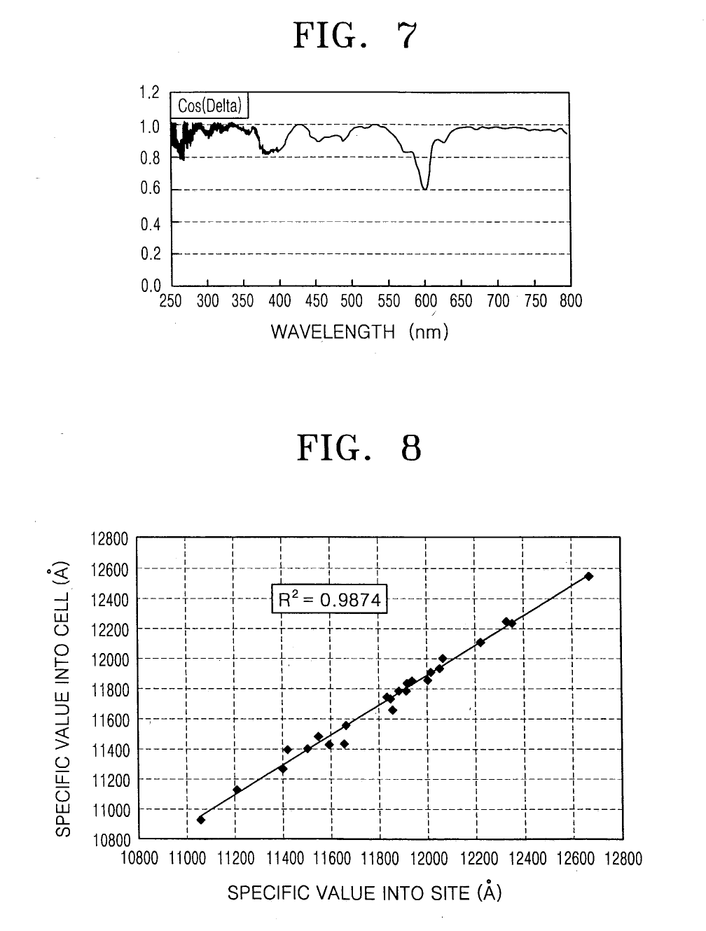

In detail, FIGS. 4 and 5 show an SE spectrum using an SE to measure the thickness of the upper layer 44 formed in a non-cell site. FIGS. 6 and 7 show an SE spectrum using an SE to measure the thickness of a thin film formed in the cell area. FIGS. 4 and 6 are graphs illustrating variations in a tangential value (tan (Ψ)) of an amplitude reflective rate (Ψ) to a wavelength of an incident beam, and FIGS. 5 and 7 are graphs illustrating variations in a cosine value (cos (Δ)) of a phase difference (Δ) to a wavelength of an incident beam.

Referring to FIGS. 4 and 5, since the lower layer 42 is either not present or formed to a uniform thickness (not of a plurality of pattern portions) in the non-cell site, an SE spectrum of a beam reflected from the upper layer 44 is periodic. Therefore, in a case where the parameters and the thickness of the lower layer 42 formed in the non-cell site are measured, it is possible to fit the SE spectrum in the entire wavelength.

As seen in FIGS. 6 and 7, an SE spectrum of a beam reflected from the upper layer 44 formed in the cell area is not periodic since the lower layer 42 is formed of a plurality of pattern portions and thus the structure of the lower layer 42 is complicated and the thickness of the lower layer 42 is non-uniform.

However, an SE spectrum of a beam reflected from each corresponding layer is periodic in a specific wavelength bandwidth. Thus, if the lower layer 42 is modelled and parameters of the lower layer 42 are properly set, fitting the SE spectrum is possible and accurate information on the thickness of the upper layer 44 can be obtained.

In a case of an SE spectrum of a portion of the upper layer 44 formed in the cell area, in a wavelength bandwidth of 300-450 nm, the structure of the portion of the upper layer 44 in the cell area is identical to that of a portion of the upper layer 44 formed in the non-cell site. Also, the lower layer 42 is formed of a material layer and modelled using a harmonic oscillator model (HOM) and using the physical amounts, such as the absorptivity, the refractive index, and the thickness, as parameters to fit the material layer into the lower layer 42. As a result, the lower layer 42 has a good correlation with an SE spectrum of a portion of the upper layer 44 formed in the non-cell site. This means that the portion of the upper layer 44 formed in the cell area has a good correlation with the portion of the upper layer 44 formed in the non-cell site. Due to this, the above-described assumptions are considered to be reliable, and thus the following experiments were carried out on various devices.

### First Experiment

The thickness of an upper layer formed in an additional non-cell site and a cell area was measured after chemical mechanical polishing (CMP) of processes of manufacturing a 4M FAST SRAM. Here, a silicon oxide layer was used as the upper layer.

The measurement of the relatively thick thickness of the upper layer was carried out during CMP in order to minimize the complexity of a lower layer and the effects of lower patterns and obtain information on the upper layer. A non-cell site, in which the measurement of the thickness of a current upper layer is being performed, e.g., the number one non-cell site (OS#1 in Table 1), and a cell area were set to measurement positions, so that thicknesses of the upper layer could be relatively compared with each other. The thickness of the upper layer was measured using an SE and analysed using a reflectivity spectrum of the SE. The reflectivity spectrum was fit by modelling. Table 1 below shows recipe conditions used when fitting the reflectivity spectrum.

TABLE 1

| | OS#1 | | | | | Cell area | | | | |
|---|---|---|---|---|---|---|---|---|---|---|
| | Film | T(Å) | N | K | Model | Film | T(Å) | N | K | Model |
| layer2 | | | | | | Oxide | 10800-12800 | 1.457 | 0 | Table |
| layer1 | Oxide | 10800-2800 | 1.458 | 0 | Table | Other | 3200-3800 | 1.3402 | 0.4157 | Ho |
| sub. | Si | | 3.8806 | 0.0199 | Table | Si | | 3.8806 | 0.0199 | Table |

| | | |
|---|---|---|
| Measured | THK1 | THK1, THK2, N1, K1 |
| value | | |

In Table 1, “sub”, “layer1”, and “layer2” denote a semiconductor substrate, and first and second material layers sequentially formed on the semiconductor substrate, respectively. “Oxide” represents a silicon oxide layer, which is an upper layer formed in the non-cell site and the cell area. “Other” denotes a first material layer formed between a portion of the semiconductor substrate in the cell area and the silicon oxide layer, i.e. a lower layer. Also, THK1, THK2, N1, and K1 denote the thickness of a material layer used as an upper layer, the thickness of a material layer used as a lower layer in the cell area, the refractive index of the upper layer, and the absorptivity of the upper layer, respectively. “Model” denotes a model used for each of the material layers. For example, “HO” denotes a harmonic oscillator model used for the lower layer (Other) in the cell area.

As described above, the non-cell site has a simple structure in which a silicon oxide layer is formed on a semiconductor substrate, while the cell area has a slightly complicated structure in which an upper layer is formed and a lower layer is further formed between the upper layer and the semiconductor substrate. Here, as described above, the lower layer was formed of an arbitrary material layer and the absorptivity, the refractive index, and the thickness are set to fitting parameters using a HOM.

In the non-cell site, only the thickness THK1 of a silicon oxide layer, which is the first material layer and the upper layer formed on the semiconductor substrate, was measured by fitting a reflectivity spectrum. In the cell area, the thicknesses THK1 and THK2 of the upper layer and the lower layer, and the refractive index N1 and the absorptivity K1 of the upper layer were measured.

FIG. 8 shows the thickness of the upper layer formed in the non-cell site and the cell area, i.e., the thickness of the silicon oxide layer. In FIG. 8, the horizontal axis denotes the thickness of a portion of the silicon oxide layer measured in the non-cell site and the vertical axis denotes the thickness of a portion of the silicon oxide layer measured in the cell area.

As seen in FIG. 8, the thickness of the portion of the upper layer measured in the non-cell site has a good correlation (0.9874) with the thickness of the portion of the upper layer measured in the cell area. The thickness of the silicon oxide layer measured in the non-cell site is 100 Å thicker than the thickness of that measured in the cell area. However, based on the correlation, the measure value, e.g., the thickness of the silicon oxide layer formed in the non-cell site is considered to be reliable.

### Second Experiment

In the first experiment, the results of fitting due to a reflectivity spectrum were measured. Measurement of the thickness of an oxide layer is more accurately achieved when fitting the oxide layer using a SE spectrum including more information than the reflectivity spectrum. Accordingly, the thickness of the oxide layer after 2M PB3 CMP, e.g., the thickness of boron-doped phospho-silicate glass, was measured in a cell area through modelling. Also, the thickness of a portion of an oxide layer formed in a non-cell site adjacent to the cell area was also measured. Values measured in the non-cell site and the cell area were compared. The measurement was carried out at 16 points of a wafer, and two pieces of wafers were used. Also, an SE was used for the measurement. Here, parameters similar to those used in the first experiment were used for the modelling, and light having a wavelength bandwidth of 300-450 nm was used for the fitting.

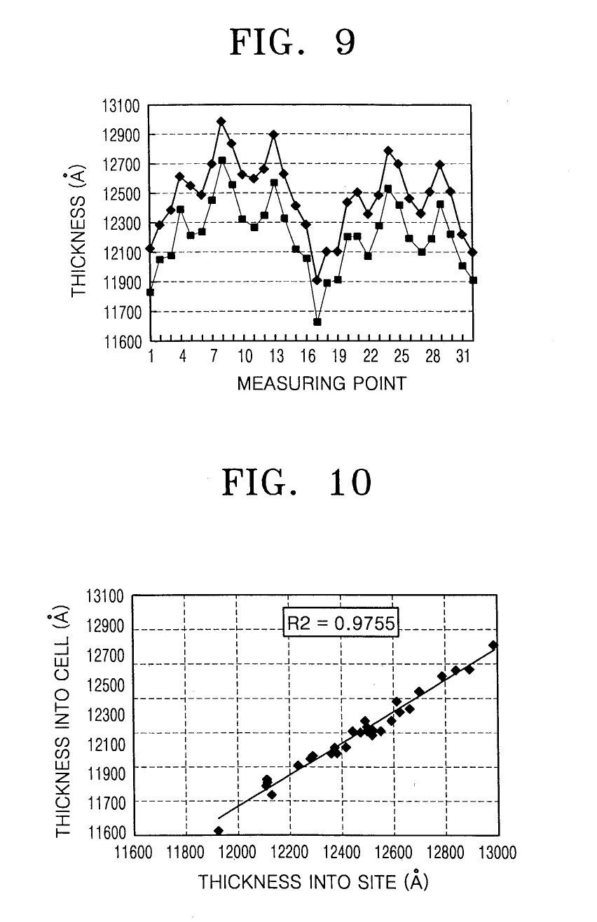

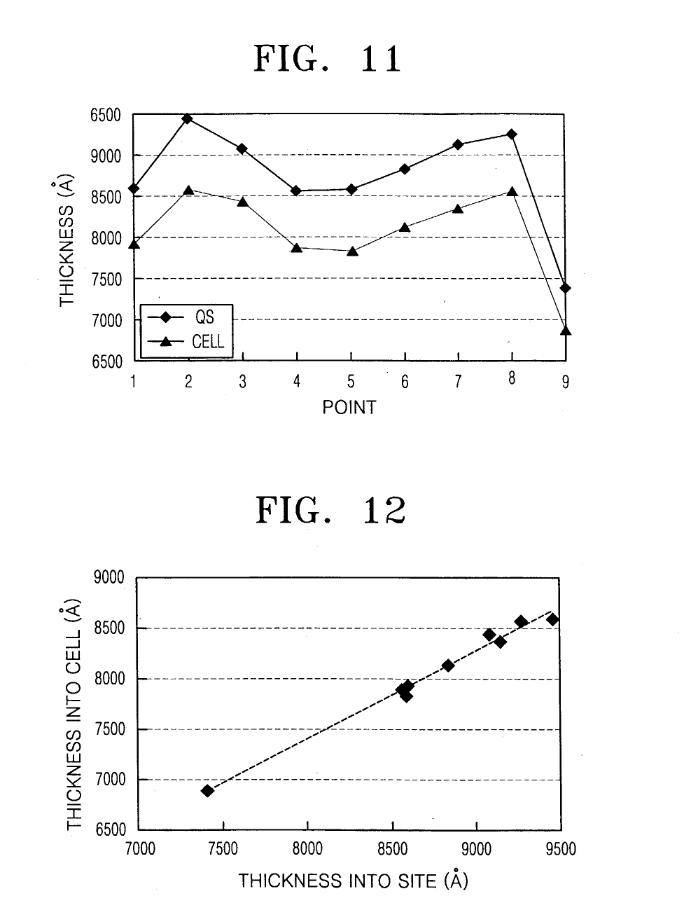

FIGS. 9 and 10 are graphs illustrating the results measured in the present experiment. FIG. 9 is a graph illustrating variations in the thickness of an oxide layer formed in a cell area and in a non-cell site close to the cell area measured at each point in the present experiment. In FIG. 9, the horizontal axis denotes the numbers of measuring points and the vertical axis denotes the thickness of the oxide layer. Also, in FIG. 9, “♦” represents variations in the thickness of a portion of the oxide layer measured in the non-cell site and “▪” represents variations in the thickness a portion of the oxide layer measured in the cell area. FIG. 10 is a graph illustrating the correlation between the thickness of the portion of the oxide layer measured in the non-cell site and the thickness of the portion of the oxide layer measured in the cell area. In FIG. 10, the horizontal axis denotes variations in the thickness of the portion of the oxide layer measured in the non-cell site and the vertical axis denotes variations in the thickness of the portion of the oxide layer measured in the cell area.

As seen in FIG. 9, as in the first experiment, the thickness of the portion of the oxide layer measured in the non-cell site is thicker than the thickness of the portion of the oxide layer measured in the cell area.

As seen in FIG. 10, as in the first experiment, values measured in the cell area have a good correlation (0.9795) with values measured in the non-cell site adjacent to the cell area.

### Third Experiment

The third experiment was carried out to observe the measurement tendencies of a DRAM, which has a different lower structure than an SRAM.

In detail, a BPSG was used as an upper layer. After the oxide layer underwent CMP, the thicknesses of portions of the oxide layer in the cell area and the non-cell site were measured and compared. The measurement was performed in non-cell sites and cell areas at 9 points per wafer. An SE was used as a measuring apparatus. Also, modelling used in the present experiment complied with the modelling techniques used in the first and second experiments. However, since fitting through modelling using a reflectivity spectrum was impossible in a process after CMP performed for a BPSG of a DRAM, modelling was carried out using an SE spectrum.

FIGS. 11 and 12 are graphs illustrating the measured results. FIG. 11 illustrates the thickness of an oxide layer in a non-cell site and a cell area measured at each point. FIG. 12 illustrates the correlation between the thickness of a portion of the oxide layer in the non-cell site and the thickness of a portion of the oxide layer in the cell area.

In FIG. 11, “♦” represents variations in the thickness of the portion of the oxide layer in the non-cell site and “▪” represents variations in the thickness of the portion of the oxide layer in the cell area. The thickness of the portion of the oxide layer measured in the non-cell site is thicker than the thickness of the portion of the oxide layer measured in the cell area.

As seen in FIG. 12, the correlation between the thicknesses of the portions of the oxide layer in the non-cell site and the cell area is about 0.9875, which is good.

### Fourth Experiment

In the first through third experiments, the relatively thick thickness of the upper layer was measured. Also, as observed from the first through third experiments, the correlation between the thicknesses of portions of the upper layer in a cell area and a non-cell site was good. In other words, in a case where the thickness of the upper layer is thick, the measurement of the thickness of the portion of the upper layer in the cell area was carried out in real-time using an SE spectrum.

Thus, even in a case where the thickness of the upper layer is thin, in order to observe the possibility of the measurement of the thin upper layer, an oxide layer, e.g., a BPSG layer, was deposited in the cell area and the non-cell site, and then the thickness of the oxide layer formed in the cell area and the non-cell site was measured. Here, an SE was used as a measuring apparatus, and the measurement was performed at 12 points of a wafer.

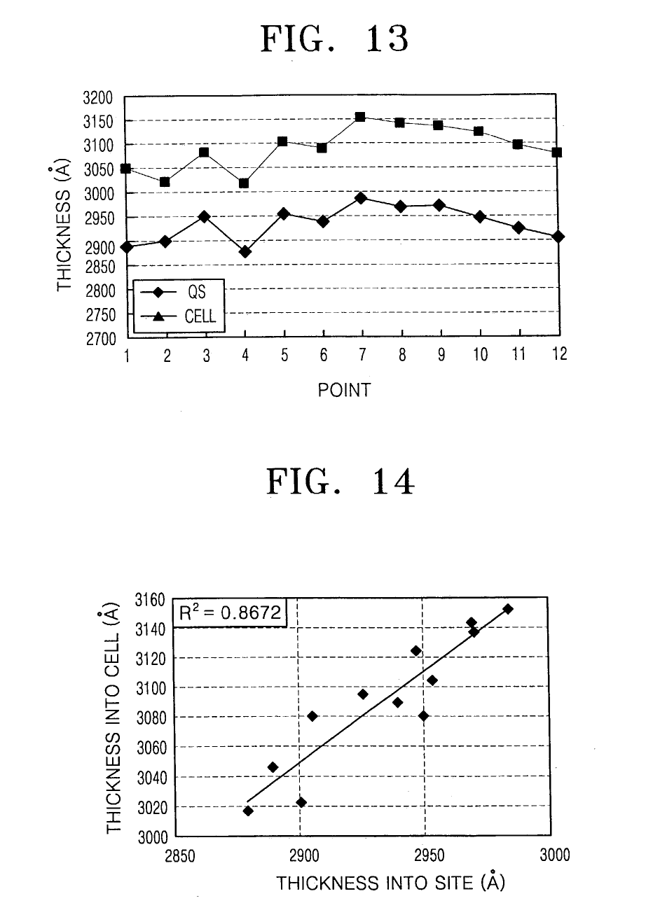

FIGS. 13 and 14 are graphs illustrating the thickness of an upper layer measured in a cell area and a non-cell site. FIG. 13 shows variations in the thickness of the upper layer measured at each point in the cell area and the non-cell site, and FIG. 14 shows the correlation between the thickness of a portion of the upper layer measured in the cell area and the thickness of a portion of the upper layer measured in the non-cell site.

In FIG. 13, “▪” and “♦” denote variations in the thicknesses of the upper layer measured in the cell area and the non-cell site, respectively. As seen in FIG. 13, the difference between values of the upper layer measured in the cell area and the non-cell site is much greater than in the first through third experiments. Also, unlike the thicknesses of the upper layer measured during CMP, the thickness of a portion of the upper layer measured in the non-cell site is thinner than the thickness of a portion of the upper layer measured in the cell area, which has to be additionally verified.

As seen in FIG. 14, the correlation between thicknesses of the upper layer measured in the cell area and the non-cell site is about 0.8627. Thus, the correlation in the present experiment, while still good, is lower than the correlations in the first through third experiments. The correlation being lower than the correlations obtained during CMP is because the upper layer is thin and thus a small amount of information is obtained from the upper layer.

### Verification

In the first through fourth experiments, the thickness of a portion an upper layer formed on a lower layer was measured in a cell area by modelling the lower layer. As a result, the thickness of the portion of the upper layer in the cell area had a good correlation with the thickness of a portion of the upper layer measured in a non-cell site near to the cell area. In order to verify the good correlation, the cell area under the non-cell site was fit and the measured thickness of the upper layer is compared with the thickness of the upper layer measured using a VSEM. The verification was carried out at 16 points of wafer. Also, the upper layer was an oxide layer, which underwent CMP.

In the verification, the thickness of the upper layer in the cell area was measured by fitting an SE spectrum, a nitride layer was formed between the upper layer and the lower layer as a particular recipe condition when fitting the SE spectrum, and a HO model was used for the nitride layer. Thus, the structure of materials stacked in the cell area is a stack of a semiconductor substrate (Si), a lower layer, a nitride layer, and an upper layer (oxide layer) from the bottom to the top. The measurement performed using light having a wavelength belonging to a bandwidth of 300-450 nm. Here, the thickness of the upper layer, the thickness of the lower layer, and the refractive index and absorptivity of the lower layer were used as parameters.

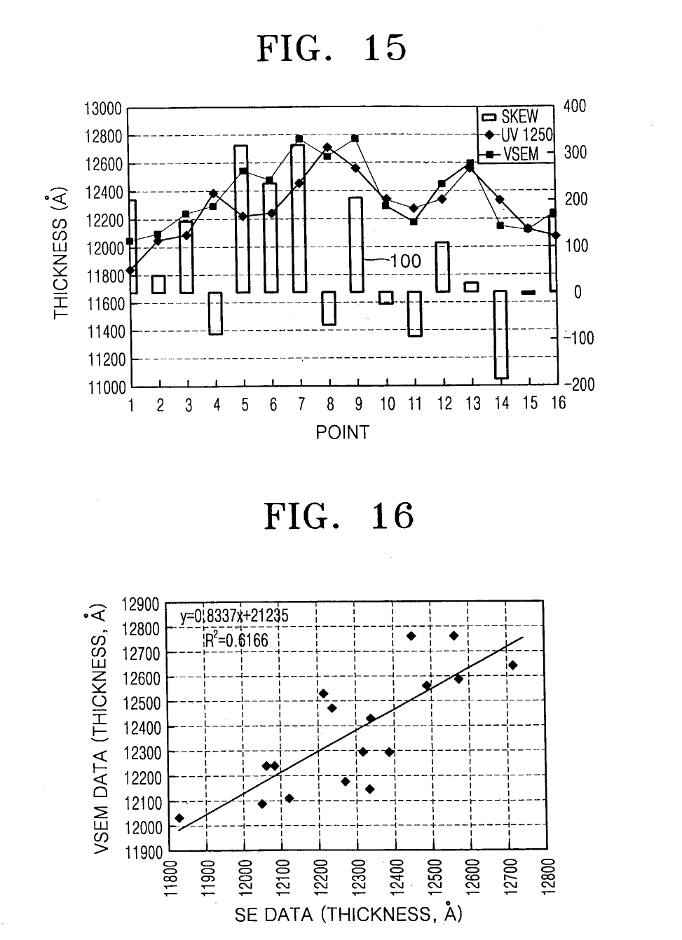

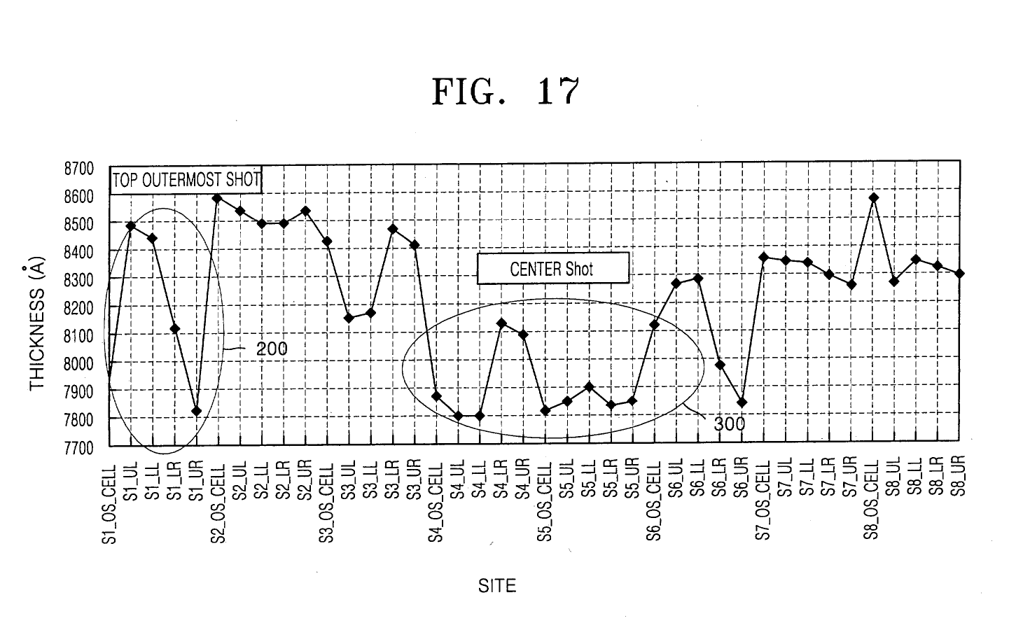

The results of the verification are shown in FIGS. 15 and 16. FIG. 15 is a graph illustrating the thickness of the upper layer measured at each point using an SE spectrum and a VSEM. In FIG. 15, “▪” represents the thickness of the upper layer measured using the VSEM and “♦” represents the thickness of the upper layer measured using the SE spectrum. Bar graphs 100 denote a skew.

FIG. 16 illustrates the correlation between the thickness of the upper layer measured by fitting the SE spectrum and the thickness of the upper layer measured using the VSEM. In FIG. 16, SE data of the horizontal axis represents variations in the thickness of the upper layer measured using the SE spectrum and the vertical represents variations in the thickness of the upper layer measured using the VSEM.

As seen in FIG. 16, the correlation between the thickness of the upper layer measured by fitting the SE spectrum and the thickness of the upper layer measured using the VSEM is about 0.6. Since a position in which the thickness of the upper layer was measured using VSEM does not accurately coincide with a position in which the thickness of the upper layer was measured using the SE spectrum, the thickness of the upper layer measured using the VSEM does not absolutely coincide with the thickness of the upper layer measured using the SE spectrum. In terms of tendency, similar results were observed. Thus, data on the thickness of the upper layer measured in the cell area could be considered to be reliable.

Measurement of the thickness uniformity of a thin layer in a shot area

In order to evaluate a method of measuring the thickness of a thin layer according to the present invention, the uniformity of a thin layer formed in a shot area which cannot be monitored according to the prior art was observed. For this, at four points in the upper left, the upper right, the lower left, and the lower right of each of 9 shot areas, the thickness of the thin layer was measured.

FIG. 17 is a graph illustrating the thickness of the thin layer measured at the four points. In FIG. 17, the horizontal axis denotes 9 shot areas and the vertical axis denotes the measured thickness of the upper layer. A front portion 200 in FIG. 17 denotes the distribution of the thickness of the upper layer in shot areas at the outermost edge of the top of wafer and a middle portion 300 denotes the distribution of the thickness of the upper layer in shot areas in the center of wafer.

As seen in FIG. 17, in the distribution of the thickness of the upper layer formed in the shot areas at the outermost edge of the top of wafer, the minimum thickness is 7800 Å and the maximum thickness is 8500 Å. Thus, the thickness uniformity shows a difference of about 700 Å. In the distribution of the thickness of the upper layer formed in the shot areas in the remaining area of wafer, the thickness uniformity shows that the difference between the minimum thickness and the maximum thickness is within the range of 100 Å-500 Å.

In a method of measuring the thickness of a thin layer according to the prior art, the thickness of the thin layer is measured in an additional non-cell site. Also, since only one non-cell site exists in a shot area, information on the thickness uniformity in the shot area cannot be obtained. In addition, since a non-cell site at the outermost edge of wafer is positioned 10-20 mm inside from the edge of wafer, the thickness uniformity cannot be observed at the edge of wafer. As described, above, in a case where the thickness of an upper layer is measured in a cell area according to the present invention, information on a thin layer formed in the cell area can be obtained in real-time. Thus, subsequent processes can be improved.

### Measurement of Thickness Uniformity of Chip

In order to observe the thickness uniformity in a chip of a device using a method of measuring the thickness of a thin layer according to the present invention, the thickness uniformity was measured in chips positioned at the outermost edge of wafer. Also, the thickness of an upper layer after CMP was measured to measure the thickness uniformity in chips. For the measurement, the thickness uniformity was measured in the outermost chips in a flat zone area of wafer, a top area facing the flat zone area, on the right and left side of the flat zone area.

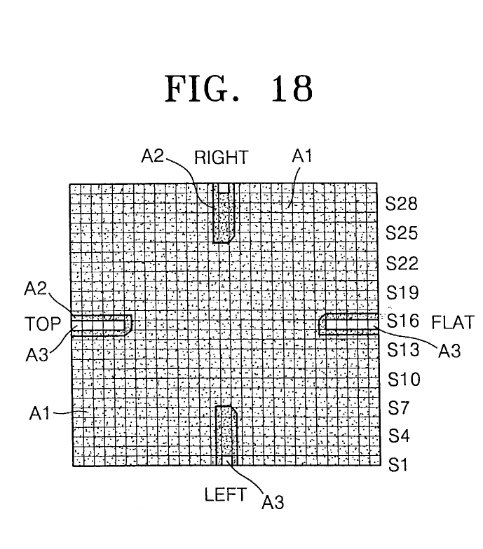

FIG. 18 shows the results of simulation for the measurement. Reference characters A1, A2, and A3 denote an area in which the thickness of an upper layer is within the range of 10500-11000 Å, an area in which the thickness of the upper layer is within the range of 11000-11500 Å, and an area in which the thickness of the upper layer is within the range of 11500-12000 Å.

As seen in FIG. 18, the thickness of a portion of the upper layer formed in the outermost chips positioned on the left L and right R areas of wafer is thinner than the thickness of a portion of the upper layer formed in chips positioned in the top area and the flat zone area of the wafer. This indicates that the portion of the upper layer formed in the outermost chips positioned on the left L and right R areas is excessively polished.

Information on the thickness uniformity in the chips cannot be obtained using a method of measuring the thickness of a thin layer in a non-cell site according to the prior art. Thus, by using a method of measuring the thickness of a thin layer according to the present invention, a portion of an upper layer which has been excessively polished during CMP may be accurately specified.

In a device used for measuring the thickness uniformity in chips, the thickness uniformity was measured in a cell including a position in which an additional non-cell site prepared to measure the thickness of a thin layer does not exist, i.e., the outermost edge. The thickness uniformity was measured after an upper layer is formed. Here, the upper layer was formed of an oxide layer, e.g., a BPSG layer.

In order to measure the thickness uniformity from the flat zone area to the top area, a recipe was set up in each chip, and then the thickness of the upper layer was measured and analyzed at four points (UL, UR, LL, and LR) of each chip.

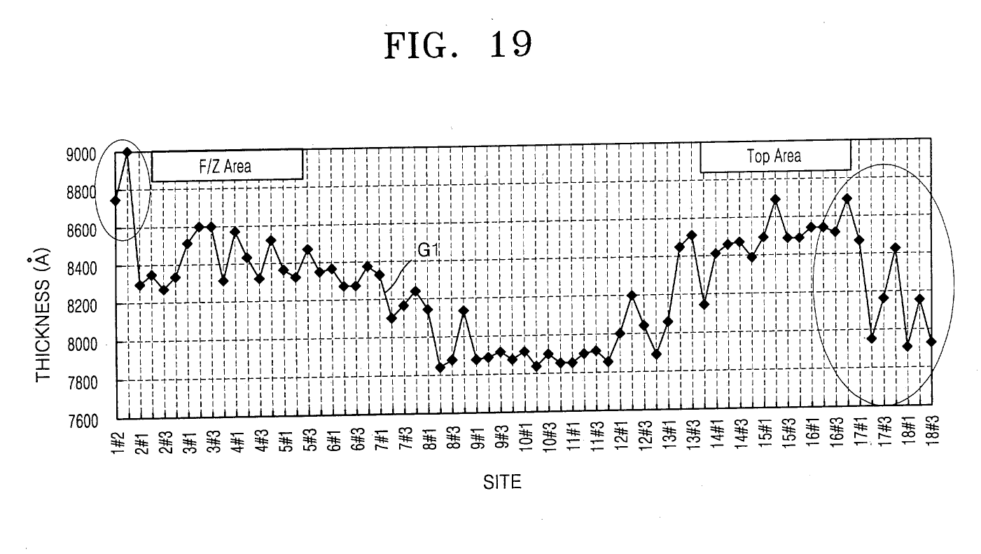

FIG. 19 is a graph illustrating the results of the measurement. In FIG. 19, the left part denotes a flat zone area and the right part denotes a top area.

As seen in FIG. 19, the thickness uniformity in two chips (numbers 17 and 18 in the horizontal axis) in the top area is within the range of 500-600 Å, which is greater than the other areas. The thickness uniformity in a chip in the flat zone area is 400-1000 Å greater than thickness uniformity in a chip in an area in which a data central value is different from those of the other areas. This may be a factor of defects of the device.

As a whole, the center of wafer is more polished than the top area and the flat zone area of wafer. The thickness uniformity in the top area is not good. These cannot be observed using a method of measuring the thickness of a thin layer according to the prior art.

Table 2 below summarizes the results of the above-described experiments and verification.

TABLE 2

| | Correlation between | Difference between | |
|---|---|---|---|
| | cell area and non- | thicknesses in cell | |
| | cell site | area and non-cell site | Others |
| First | 0.9874 | ˜100 non-cell site > cell | |
| Experiment | | area | |
| Second | 0.9795 | ˜200 non-cell site > cell | |
| Experiment | | area | |
| Third | 0.9975 | ˜700 (non-cell site > cell | |
| Experiment | | area | |
| Fourth | 0.8627 | ˜150 cell area > non-cell | |
| Experiment | | site | |
| Verification | 0.6196 | ±300 | |

Referring to Table 2, in all experiments and verification using an SE spectrum, good correlations between the thicknesses of an upper layer measured in a non-cell site and a cell area are obtained. Also, in terms of CMP, the thickness of a portion of the upper layer formed in the cell area is thinner than the thickness of a portion of the upper layer formed in the non-cell site. In terms of BPSG deposition, the opposite case occurs. In addition, the thicker the thickness of the upper layer, the better the correlations between thicknesses of the upper layer in the cell area and the non-cell site and the more accurate the measurement of the thickness of the upper layer in the cell area.

In the verification of the present invention using a VSEM, accurate point matching cannot be achieved when matching with the VSEM and an error of about ±300 Å occurs due to an error occurring in the VSEM. However, in terms of tendency, the results are similar. Thus, data on the thickness of the upper layer measured using method of measuring the thickness of a thin layer according to the present invention is reliable.

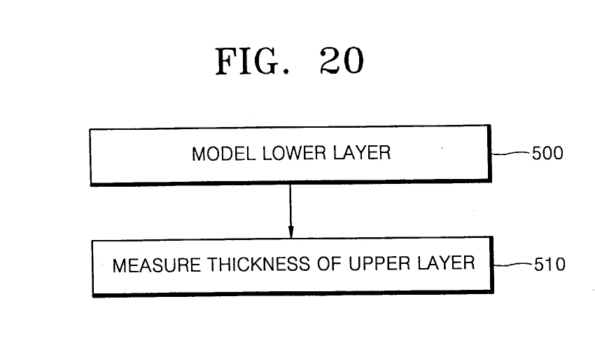

FIG. 20 is a block diagram for explaining summarized steps of a method of measuring the thickness of a thin layer according to the present invention. In step 500, a lower layer formed on a substrate is modelled. In step 510, the thickness of an upper layer formed on the lower layer is measured. The lower layer is modelled using a HO model and the thickness of the upper layer is measured using an SE spectrum as described in the above experiments.

As described above, in a method of measuring the thickness of a thin layer according to the present invention, an SE spectrum is used and a lower layer is modelled to measure the thickness of an upper layer that is unbreakable and formed on the lower layer. Using the method, the thickness of the upper layer in a cell area, particularly in a shot area or a chip area that cannot be monitored according to the prior art, can be measured, so that the thickness uniformity in the cell area, the shot area, or the chip area can be measured. The thickness uniformity in chips positioned at the edge of wafer can be measured for improvement of processes and analysis of problems of the processes. In particular, since the thickness of the upper layer is thick, the thickness of the upper layer can be stably measured. The method of the present invention can be applied to CMP in which the whole thickness uniformity in the wafer is important to double the improvement of the processes.

The present invention has been particularly shown and described with reference to exemplary embodiments thereof. However, the embodiments of the present invention can be modified into various other forms, and the scope of the present invention must not be interpreted as being restricted to the embodiments. For example, it will be understood by those of ordinary skill in the art that an apparatus for measuring the thickness of a thin layer other than an SE can be used, the structure of an SE can be modified, or an SE having an additional element can be used. Thus, the scope of the present invention is defined by the appended claims rather than by the above-described embodiments.

What is claimed is:

1. A method of measuring the thickness of an upper layer which is formed over a lower layer, the lower layer defined by a pattern of spaced apart portions formed over a substrate, said method comprising:
(a) modeling the lower layer; and
(b) measuring the thickness of the upper layer.

2. The method of claim 1, wherein said modeling of the lower layer comprises:
(a1) setting the lower layer as a predetermined material layer; and
(a2) fitting the material layer into the lower layer using a harmonic oscillator model.

3. The method of claim 2, wherein asorptivity, refractive index, and thickness of the material layer are used as parameters in the harmonic oscillator model.

4. The method of claim 1, wherein an upper surface of the upper layer has been subject to chemical mechanical polishing.

5. The method of claim 1, wherein the thickness of a portion of the upper layer formed in a predetermined area of the substrate is measured, and wherein the predetermined area includes at least a cell area.

6. The method of claim 1, wherein the thickness of the upper layer is measured using a spectroscope ellipsometer.

7. The method of claim 5, wherein the thickness of the upper layer is measured using a spectroscope ellipsometer.
